(19) United States
(12) Patent Application Publication
(10) Pub. No.: US 2024/0224004 A1
(43) Pub. Date: Jul. 4, 2024

(54) SYSTEM MESSAGE UPDATE METHOD, SYSTEM MESSAGE UPDATE APPARATUS, AND STORAGE MEDIUM

(71) Applicant: Beijing Xiaomi Mobile Software Co., Ltd., Beijing (CN)

(72) Inventor: Qin MU, Beijing (CN)

(73) Assignee: Beijing Xiaomi Mobile Software Co., Ltd., Beijing (CN)

(21) Appl. No.: 18/557,453

(22) PCT Filed: Apr. 26, 2021
(86) PCT No.: PCT/CN2021/090045

§ 371 Date: Oct. 26, 2023

(51) Int. Cl. H04W 4/14; H04W 8/24

(52) U.S. Cl. CPC H04W 4/14; H04W 8/24

(57) ABSTRACT

A system message update method. The system message update method is applied to a terminal, and includes receiving a system message update indication, wherein the system message update indication includes a plurality of information fields, and the plurality of information fields are used for instructing different types of terminals to perform a system message update, and performing the system message update on the basis of an information field corresponding to the type of a terminal.

### CROSS-REFERENCE OF RELATED APPLICATION

The present application is a National Stage of International Application No. PCT/CN2021/090045, filed on Apr. 26, 2021, the contents of all of which are incorporated by reference herein in their entireties for all purposes.

### BACKGROUND

### Technical Field

The present disclosure relates to the field of wireless communication technology, in particular to a system message update method, a system message update apparatus, and a storage medium.

### Description of the Related Art

In a mobile communication system, change in system message will trigger a Paging message to notify the terminal that the system message needs to be updated. The information field is used to notify the terminal that the system message needs to be updated, and the information field can be found in Paging Downlink Control Information (DCI). The information field used to notify system message change in Paging DCI includes the Short message indicator information field and the Short message information field. The Short message indicator information field is used to indicate whether the current paging contains system message update indication and/or paging to the terminal, while the Short Message information field is used to indicate the type of system message where the current system message has been updated.

### SUMMARY

According to a first aspect of the embodiments of the present disclosure, it provides a system message update method, applied to a terminal, including receiving a system message update indication, where the system message update indication includes a plurality of information fields, and the plurality of information fields are used to instruct different types of terminals to perform system message update, and performing the system message update based on an information field corresponding to a type of the terminal.

According to a second aspect of the embodiments of the present disclosure, it provides a system message update method, applied to a network-side device, including transmitting a system message update indication, wherein the system message update indication includes a plurality of information fields, and the plurality of information fields are used to instruct different types of terminals to perform system message update.

According to a third aspect of the embodiments of the present disclosure, it provides a system message update apparatus, applied to a terminal, including a receiving module configured to receive a system message update indication, wherein the system message update indication includes a plurality of information fields, and the plurality of information fields are used to instruct different types of terminals to perform system message update, and an updating module configured to perform the system message update based on an information field corresponding to a type of the terminal.

According to a fourth aspect of the embodiments of the present disclosure, it provides a system message update apparatus, applied to a network-side device, including a transmitting module configured to transmit a system message update indication, where the system message update indication includes a plurality of information fields, and the plurality of information field is used to instruct different types of terminals to perform system message update.

According to a fifth aspect of the embodiments of the present disclosure, it provides a system message update apparatus, including a processor and a memory configured to store processor executable instructions. The processor is configured to execute the system message update method according to the first aspect or any implementation in the first aspect, or to execute the system message update method according to the second aspect or any implementation in the second aspect.

According to a sixth aspect of the embodiments of the present disclosure, it provides a non-transitory computer-readable storage medium, wherein a mobile terminal is enabled to execute the system message update method according to the first aspect or any implementation in the first aspect when instructions in the storage medium are executed by a processor of the mobile terminal, or the mobile terminal is enabled to execute the system message update method according to the second aspect or any implementation in the second aspect.

It should be understood that the general description above and the detailed description in the following text are only illustrative and explanatory, and do not limit this disclosure.

### BRIEF DESCRIPTION OF THE DRAWINGS

The accompanying drawings here are incorporated into the specification and form a part of this specification, showing embodiments that comply with the present disclosure, and are used together with the specification to explain the principles of the present disclosure.

FIG. 1 is an architecture diagram of a communication system of a network device and a terminal illustrated according to an exemplary embodiment.

FIG. 2 is a flowchart of a system message update method illustrated according to an exemplary embodiment.

FIG. 3 is a flowchart of another system message update method illustrated according to an exemplary embodiment.

FIG. 4 is a flowchart of another system message update method illustrated according to an exemplary embodiment.

FIG. 5 is a flowchart of another system message update method illustrated according to an exemplary embodiment.

FIG. 6 is a block diagram of a system message update apparatus according to an exemplary embodiment.

FIG. 7 is a block diagram of another system message update apparatus illustrated according to an exemplary embodiment.

FIG. 8 is a block diagram of an apparatus for updating system message illustrated according to an exemplary embodiment.

FIG. 9 is a block diagram of another apparatus for updating system message illustrated according to an exemplary embodiment.

### DETAILED DESCRIPTION OF THE PREFERRED EMBODIMENTS

Here, a detailed explanation will be given of exemplary embodiments, which are illustrated in the accompanying drawings. When the following description refers to the accompanying drawings, unless otherwise indicated, the same numbers in different drawings represent the same or similar elements. The embodiments described in the following exemplary embodiments do not represent all embodiments consistent with this disclosure. On the contrary, they are only examples of devices and methods that are consistent with some aspects of the present disclosure as detailed in the attached claims.

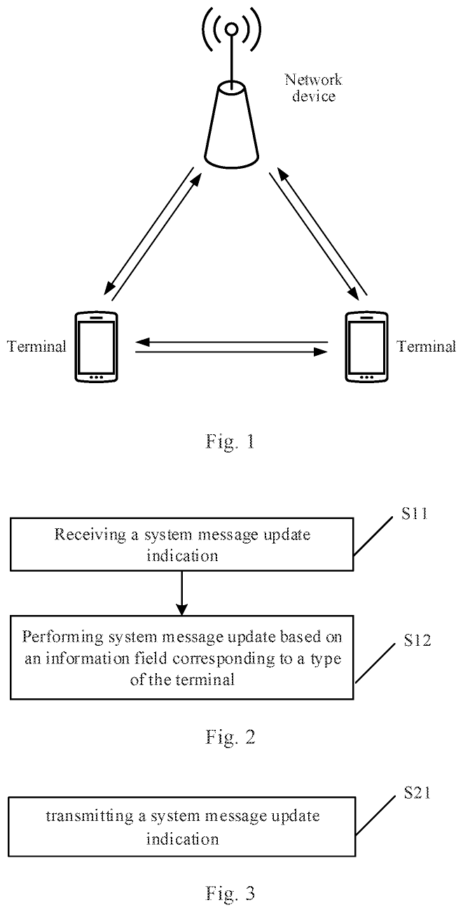

FIG. 1 is an architecture diagram of a communication system of a network device and a terminal illustrated according to an exemplary embodiment. The communication method provided in this disclosure can be applied to the architecture diagram of communication system shown in FIG. 1. As shown in FIG. 1, network-side device can transmit signaling based on the architecture shown in FIG. 1.

It can be understood that the communication system of the network device and the terminal shown in FIG. 1 is only a schematic explanation, and the wireless communication system may also include other network devices, such as core network devices, wireless relay devices, and wireless return devices, which are not shown in FIG. 1. The embodiments of the present disclosure do not limit the number of network devices and terminals included in the wireless communication system.

It can be further understood that the wireless communication system of the embodiments of the present disclosure is a network that provides wireless communication function. Wireless communication system can adopt different communication technologies, such as code division multiple access (CDMA), broadband code division multiple access (WCDMA), time division multiple access (TDMA), frequency division multiple access (FDMA), orthogonal frequency division multiple access (OFDMA), Single Carrier FDMA (SC-FDMA), Carrier Sense Multiple Access with Collision Avoidance. According to factors such as capacity, speed, and latency of different networks, networks can be classified into 2G (generation) network, 3G network, 4G network, or future evolution network, such as 5G network, where 5G can also be referred to as New Radio (NR). For the convenience of description, the wireless communication network is sometimes referred to as network in this disclosure.

Furthermore, the network device referred to in this disclosure can also be referred to as wireless access network device. The wireless access network device can be: base station, evolved node B (base station), home base station, access point (AP) in wireless fidelity (WIFI) system, wireless relay node, wireless return node, transmission point (TP) or transmission and reception point (TRP), etc., or the wireless access network device can also be gNB in NR system, or can be components or a part of devices that make up the base station. When used as a vehicle-to-everything (V2X) communication system, the network device can also be a vehicle-amounted device. It should be understood that in the embodiments of the present disclosure, the specific technology and device form used by the network device are not limited.

Furthermore, the terminal referred to in this disclosure can also be referred to as terminal device, user equipment (UE), mobile station (MS), mobile terminal (MT), etc., and is a device that provides voice and/or data connectivity to users. For example, the terminal can be handheld device, vehicle-mounted device, etc, with wireless connectivity. Currently, some examples of terminals include smartphone (Mobile Phone). Pocket Personal Computer (PPC), handheld computer. Personal Digital Assistant (PDA), laptop, tablet, wearable device, or vehicle-mounted device. In addition, when used as a vehicle-to-everything (V2X) communication system, the terminal device can also be a vehicle-mounted device. It should be understood that the specific technology and device form used by the terminal in the embodiments of the present disclosure are not limited.

Due to the vigorous development of the Internet of Things, it has brought many conveniences to human life and work. Machine Type Communication (MTC) and Narrow Band Internet of Things (NB IoT) are typical representatives of cellular IoT technology. At present, these technologies have been widely used in many domains such as smart cities (such as meter reading), smart agriculture (such as temperature and humidity information collection), and smart transportation (such as shared bicycles).

In communication system, two technologies. MTC and NB IoT, are proposed for scenarios of low speed and high latency in IoT services, such as meter reading and environmental monitoring. At present. NB IoT technology can support a maximum rate of several hundred Kbps, while MTC can support a maximum rate of several Mbps. However, with the continuous development of IoT services (such as monitoring, smart home, wearable device, and industrial sensor detection), the rate of tens to one hundred Mbps is generally required, and the requirement for latency is also relatively high. Therefore, in communication system, the two technologies of MTC and NB IoT cannot meet the current requirements of IoT services. On the other hand, the two technologies of MTC and NB IoT are generally deployed in scenarios such as basement, outdoor, and other places where it is difficult to charge or replace battery. Therefore, terminals associated with MTC and NB IoT technologies are limited by hardware, resulting in lower coverage capability than typical wireless communication terminals. And due to the influence of the application environment, the power savings of their devices are also characteristics of MTC and NB IoT technologies. Based on this situation, it has been proposed to design a new user equipment in 5G NR to cover the requirement of this mid-range IoT device. In the current 3GPP (Third Generation Partnership Project) standardization, this new type of terminal is called Redcap terminal or simply NR lite (New Radio in a lean version).

In the new generation of communication technology, reduced capability (Redcap) terminal is introduced. In related art, the system message change indication for Redcap terminal is different from that for other type of terminal. Therefore, if within the same cell, the network-side device transmits system message change indication for Redcap terminal, or the network-side device transmit system message change indication for non-Redcap terminal. A Paging message will be triggered, and the Paging DCI indicates that the system message has changed, causing all terminals to update the system message. However, for some terminals, it is not necessary to update the system message, resulting in a waste of power for these terminals.

For the Redcap terminal, there are system messages specific to the Redcap terminal. For example, there is a dedicated system message indication to notify whether the Redcap terminal is allowed to access the current cell or frequency. In the Redcap terminal, the system message indications for Redcap terminal with 1 antenna and Redcap terminal with 2 antennas have the following descriptions: specify system information indication to indicate whether the Redcap terminal can reside in the cell/frequency: this indication should be possibly specific to the number of antennas of the terminal.

The process of updating system messages is as follows.

When a system message changes, a paging will be triggered, and there is an information field in the paging DCI that notifies the system message change. It mainly includes the short message indication information field and the short message information field. Referring to Table 1, the short message indication information field is used to indicate whether the current paging message contains system message update indication and/or paging to the terminal. Referring to Table 2, the short message information field is used to indicate the type of update to the current system message. The terminal performs targeted system message update based on the short message indication.

TABLE 1

| Bit field | Short Message indication |
|---|---|
| 00 | Reserved |
| 01 | Only scheduling information for Paging is present in the DCI |
| 10 | Only short message is present in the DCI |
| 11 | Both scheduling information for Paging and short message is |
| | present in the DCI |

It can be understood that each element in Table 1 exists independently, and these elements are exemplarily listed in the same table, but it does not mean that all elements in the table must exist simultaneously as shown in the table. The value of each element is independent of value of any other element in Table 1. Therefore, those skilled in the art can understand that the value of each element in Table 1 is an independent embodiment.

TABLE 2

| Bit | Short Message |
|---|---|
| 1 | System info Modification |
| | If set to 1:indication of a BCCH modification other then SIB6, SIB7 |
| | and SIB8 |
| 2 | Etws And Cmas Indication |
| | If set to 1:indication of an ETWS primary notification and/or an |
| | ETWS secondary notification and/or CMAS notification |
| 3 | Stop paging monitoring |
| | This bit can be used for an only operation with shared spectrum |
| | channel access and if nrofPDCCH-Monitoring Occasion Per SSB-In |
| | PO is present |
| | If set to 1:indication that the UE may stop |
| | monitoring PDCCH occasion(s) for paging Occasion as specified |
| | in TS 38.304[20], clause7.1 |
| 4-8 | Not used in this release of the specification, and shall be ignored |
| | by UE received |

It can be understood that each element in Table 2 exists independently, and these elements are exemplarily listed in the same table, but it does not mean that all elements in the table must exist simultaneously as shown in the table. The value of each element is independent of value of any other element in Table 2. Therefore, those skilled in the art can understand that the value of each element in Table 2 is an independent embodiment.

Based on the embodiment of triggering paging mentioned above, it can be seen that in related art, changes in Redcap terminal specific system message contained in the Remaining Minimum System Information (RMSI) will trigger paging, and the system message indication in the paging DCI will indicate that system message changes. All terminals in the cell will update system messages. However, for non-Redcap terminals, there is no need to update the system messages, which leads to power waste. Moreover, the number of antennas available in Redcap terminals also varies. If the system message for a Redcap terminal with a certain number of antennas changes, there is no need for other types of terminals to update the system messages. Similarly, when there are changes in system messages of non-Redcap terminals in RMSI, the indication methods in related art can also bring unnecessary system message updates to Redcap terminals, leading to power waste.

Based on this, the present disclosure provides a method for updating system message. A plurality of information fields are used in paging DCI, with each information field indicating different type of terminal for system message update. Different types of terminals can be targeted instructed to update system messages, avoiding unnecessary system message updates which result in power waste.

FIG. 2 is a flowchart of a system message update method illustrated according to an exemplary embodiment. As shown in FIG. 2, the system message update method is used in the terminal, and includes the following steps.

In step S11, receiving a system message update indication.

In the embodiments of the present disclosure, the terminal receives a system message update indication, wherein the system message update indication includes a plurality of information fields, which are used to instruct different types of terminals to update system messages.

In step S12, performing system message update based on the information field corresponding to a type of the terminal.

In the embodiments of the present disclosure, the terminal determines the corresponding information field based on its own type, and determines to perform system update based on the indication of the information field.

By using the system message update method provided in the present disclosure, different types of terminals can be instructed to update the system messages based on a plurality of information fields of the system message update indication. The terminal can read the information field corresponding to its own type, and determine the system message update, thereby avoiding all terminals from updating the system message, and reducing power waste.

In some embodiments of the present disclosure, a plurality of information fields at least include a first information field and a second information field. The first information field is used to instruct a first type terminal to perform system message update, and the second information field is used to instruct a second type terminal to perform system message update. It should be noted that the capability of the first type terminal is different from that of the second type terminal. For example, the first type terminal can be a normal terminal, and the second type terminal can be a Redcap terminal.

In some embodiments of the present disclosure, if the first type terminal has a higher-level capability than the second type terminal, then the second type terminal also includes a first sub-type terminal and a second sub-type terminal. For example, if the second type terminal is a Redcap terminal, then the second type terminal also includes a Redcap terminal with one antenna and a Redcap terminal with two antennas. For the convenience of description, the Redcap terminal with one antenna and the Redcap terminal with two antennas are referred to as the first sub-type terminal and the second sub-type terminal, respectively. The second information field corresponding to the second type terminal also includes the first information sub-field corresponding to the first sub-type terminal and the second information sub-field corresponding to the second sub-type terminal. The first information sub-field is used to instruct the first sub-type terminal to update system message, and the second information sub-field is used to instruct the second sub-type terminal to update system message.

In some embodiments of the present disclosure, the first and second information fields may be bits in the short message information field, but this is only an example and not a specific limitation to the present disclosure.

If the information field is a bit in a short message information field, then the first information field can be a first number of bits in the short message information field, and the first number of bits are used to indicate different system messages for the first type terminal. The second information field is a second number of bits in the short message information field, where the second number of bits are different from the first number of bits. The second number of bits are used to indicate the system message for the first sub-type terminal and the system message for the second sub-type terminal, respectively.

For example, please refer to Table 3. The first number of bits can be the first three bits in the short message information field. The first bit is used to indicate a change in the system message. In response to the first bit being set to 1, it indicates the Broadcast Control Channel (BCCH) other than SIB6, SIB7, and SIB8 is modified. The second bit is the etwsAndCmasIndication bit. In response to the second bit being set to 1, it indicates ETWS primary notification and/or ETWS secondary notification and/or CMAS notification. The third bit is used to indicate sharing the spectrum.

The second number of bits can be the last few bits starting from the fourth bit in the short message, where the fourth bit is used to indicate system message modification for Redcap terminal with 1 antenna. In response to the fourth bit being set to 1, it indicates that the BCCH other than SIB6, SIB7, and SIB8 is modified for Redcap terminal with 1 antenna. The fifth bit is used to indicate system message modification for Redcap terminal with 2 antennas. In response to the fifth bit being set to 1, it indicates that the BCCH other than SIB6, SIB7, and SIB8 is modified for Redcap terminal with 2 antennas. The sixth to eighth bits are reserved bits.

TABLE 3

| Bit | Short Message |
|---|---|
| 1 | System Info Modification |
| | If set to 1: indication of a BCCH modification other than SIB6, SIB7 |
| | and SIB8. |
| 2 | etwsAndCmasIndication |
| | If set to 1: indication of an ETWS primary notification and/or an |
| | ETWS secondary notification and/or a CMAS notification. |
| 3 | Used in the shared spectrum |
| 4 | System Info Modification-Redcap 1Rx |
| | If set to 1: indication of a BCCH modification other than SIB6, SIB7 |
| | and SIB8 for Redcap with 1Rx |
| 5 | SystemInfoModification-Redcap 2Rx |
| | If set to 1: indication of a BCCH modification other than SIB6, SIB7 |
| | and SIB8 for Redcap with 2Rx |
| 6-8 | Reserved |

It can be understood that each element in Table 3 exists independently, and these elements are exemplarily listed in the same table, but it does not mean that all elements in the table must exist simultaneously as shown in the table. The value of each element is independent of value of any other element in Table 3. Therefore, those skilled in the art can understand that the value of each element in Table 3 is an independent embodiment.

In the embodiments of the present disclosure,

the
system messages monitored by the first type terminal and the second type terminal or applicable for the first type terminal and the second type terminal are different. For example, the second type terminal needs to monitor a system message of whether the system allows such terminal to access, while the first type terminal does not need to monitor this system message. Moreover, the system messages for the first sub-type terminal and the second sub-type terminal in the second type terminal are also different.

Based on the same concept, the embodiments of the present disclosure also provide a system message update method.

FIG. 3 is a flowchart of a system message update method illustrated according to an exemplary embodiment. As shown in FIG. 3, the system message update method is used in network-side device, and includes the following steps.

In step S21, transmitting a system message update indication.

In the embodiment of the present disclosure, the system message update indication includes a plurality of information fields, which are used to instruct different types of terminals to perform system message update.

In some embodiments of the present disclosure, the network-side device transmits system message update indication, and the terminal determines the corresponding information field based on its own type, and determines to perform system update based on the indication of the information field.

Through the system message update method provided in the present disclosure, network-side device can instruct different types of terminals to update system messages in a plurality of information fields of the system message update indication. The terminals can read the information fields corresponding to their own types to determine system message updates, avoiding all terminals from updating system messages and reducing power waste.

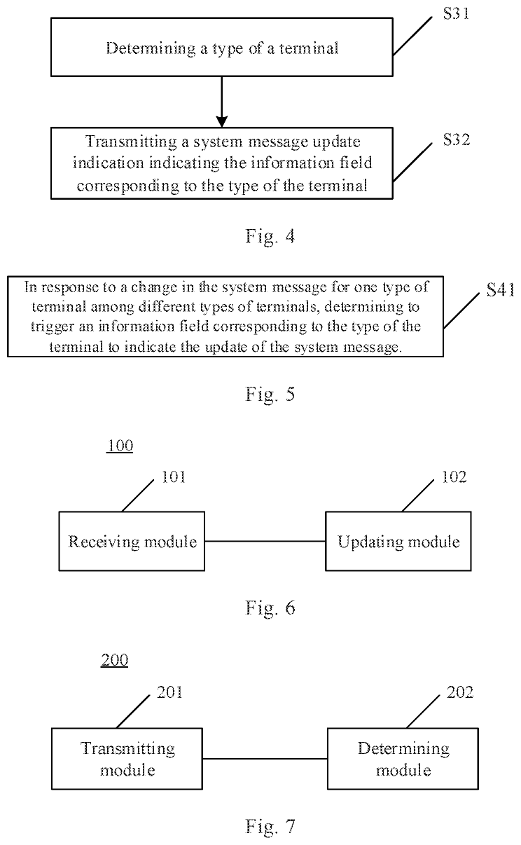

FIG. 4 is a flowchart of a system message update method illustrated according to an exemplary embodiment. As shown in FIG. 4, the system message update method is used in network-side device, and includes the following steps.

In step S31, determining a type of a terminal.

In step S32, transmitting a system message update indication indicating the information field corresponding to the type of the terminal.

In the embodiment of the present disclosure, the network-side device can determine the type of terminal that currently requires system message update, transmit a system message update indication, and transmit an information field corresponding to the terminal type in the system message update indication, so as to instruct this type of terminal to update system message.

In some embodiments of the present disclosure, a plurality of information fields at least include a first information field and a second information field. The first information field is used to instruct a first type terminal to perform system message update, and the second information field is used to instruct a second type terminal to perform system message update. It should be noted that the capability of the first type terminal is different from that of the second type terminal. For example, the first type terminal can be a normal terminal, and the second type terminal can be a Redcap terminal.

In some embodiments of the present disclosure, if the first type terminal has a higher-level capability than the second type terminal, then the second type terminal also includes a first sub-type terminal and a second sub-type terminal. For example, if the second type terminal is a Redcap terminal, then the second type of terminal also includes a Redcap terminal with one antenna and a Redcap terminal with two antennas. For the convenience of description, the Redcap terminal with one antenna and the Redcap terminal with two antennas are referred to as the first sub-type terminal and the second sub-type terminal. The second information field corresponding to the second type terminal also includes the first information sub-field corresponding to the first sub-type terminal and the second information sub-field corresponding to the second sub-type terminal. The first information sub-field is used to instruct the first sub-type terminal to update system message, and the second information sub-field is used to instruct the second sub-type terminal to update system message.

In some embodiments of the present disclosure, the first and second information fields may be bits in the short message information field, but this is only an example and not a specific limitation to the present disclosure.

If the information field is a bit in a short message information field, the first information field can be a first number of bits in the short message information field, and the first number of bits are used to indicate different system messages for the first type terminal. The second information field is a second number of bits in the short message information field, where the second number of bits are different from the first number of bits. The second number of bits are used to indicate the system message for the first sub-type terminal and the system message for the second sub-type terminal, respectively.

For example, please refer to Table 3. The first number of bits can be the first three bits in the short message information field. The first bit is used to indicate a change in the system message. In response to the first bit being set to 1, it indicates the BCCH other than SIB6, SIB7, and SIB8 is modified. The second bit is used to indicate ETWS and CMAS. In response to the second bit being set to 1, it indicates ETWS primary notification and/or ETWS secondary notification and/or CMAS notification. The third bit is used to indicate sharing the spectrum.

The second number of bits can be the last few bits starting from the fourth bit in the short message, where the fourth bit is used to indicate system message modification for Redcap terminal with 1 antenna. In response to the fourth bit being set to 1, it indicates that the BCCH other than SIB6, SIB7, and SIB8 is modified for Redcap terminals with 1 antenna. The fifth bit is used to indicate system message modification for Redcap terminal with 2 antennas. In response to the fifth bit being set to 1, it indicates the BCCH other than SIB6, SIB7, and SIB8 is modified for Redcap terminal with 2 antennas. The sixth to eighth bits are reserved bits.

In the embodiments of the present disclosure, the system messages monitored by the first type terminal and the second type terminal or applicable to the first type terminal and the second type terminal are different. For example, the second type terminal needs to monitor a system message of whether the system allows such terminal to access, while the first type terminal does not need to monitor this system message. Moreover, the system messages for the first sub-type terminal and the second sub-type terminal in the second type terminal are also different.

FIG. 5 is a flowchart of a system message update method illustrated according to an exemplary embodiment. As shown in FIG. 5, the system message update method is used in network-side device, and includes the following steps.

In step S41, in response to a change in the system message for one type of terminal among different types of terminals, determining to trigger an information field corresponding to the type of the terminal to indicate the update of the system message.

In the embodiment of the present disclosure, the network side can also modify the system message for a certain type of terminal, transmit system message update indication to that type of terminal, trigger the information field corresponding to that type of terminal, and instruct that type of terminal to update the system message.

Based on the same concept, the embodiments of the present disclosure also provide a system message update device.

It can be understood that the system message update device provided in the embodiments of the present disclosure includes hardware structures and/or software modules corresponding to the execution of each function in order to achieve the above functions. In combination with the units and algorithm steps of the examples disclosed in the embodiments of the present disclosure, the embodiments of the present disclosure can be implemented in the form of hardware or a combination of hardware and computer software. Whether a certain function is implemented by hardware or by computer software driving hardware depends on the specific application and design constraints of the technical solution. Those skilled in the art may use different methods to implement the described functions for each specific application, but such implementation should not be considered beyond the scope of the technical solution of the embodiments of the present disclosure.

FIG. 6 is a block diagram of a system message update apparatus illustrated according to an exemplary embodiment. Referring to FIG. 6, the system message update apparatus 100 includes a receiving module 101 and an updating module 102.

The receiving module 101 is used to receive system message update indication. The system message update indication includes a plurality of information fields, and the a plurality of information fields are used to indicate different types of terminals to update system messages. The updating module 102 is used to update system message based on the information field corresponding to the terminal type.

In the embodiment of the present disclosure, a plurality of information fields at least include a first information field and a second information field. The first information field is used to instruct a first type terminal to perform system message update, and the second information field is used to instruct a second type terminal to perform system message update. The capability of the first type terminal is different from that of the second type terminal. For example, the first type terminal can be a normal terminal, and the second type terminal can be a Redcap terminal.

In the embodiment of the present disclosure, the first type terminal has a higher-level capability than the second type terminal. The second type terminal includes the first sub-type terminal and the second sub-type terminal. The second information field at least includes a first information sub-field and a second information sub-field. The first information sub-field is used to instruct the first sub-type terminal to update system message, and the second information sub-field is used to instruct the second sub-type terminal to update system message.

In the embodiment of the present disclosure, the first information field is the first number of bits in the short message information field, and the first number of bits are used to indicate different system messages for the first type terminal. The second information field is a second number of bits in the short message information field, where the second number of bits are different from the first number of bits. The second number of bits are used to indicate the system message for the first sub-type terminal and the system message for the second sub-type terminal, respectively.

In the embodiment of the present disclosure, the system messages of different types of terminals are different.

FIG. 7 is a block diagram of a system message update apparatus illustrated according to an exemplary embodiment. Referring to FIG. 7, the system message update apparatus 200 includes a transmitting module 201.

The transmitting module 201 is used to transmit system message update indication. The system message update indication includes a plurality of information fields, and the plurality of information fields are used to indicate different types of terminals to update system messages.

In the embodiment of the present disclosure, the apparatus further includes a determining module 202.

The determining module 202 is used to determine terminal type. The transmitting module 201 is used to transmit system message update indication of the information field corresponding to the terminal type.

In the embodiment of the present disclosure, a plurality of information fields at least include a first information field and a second information field. The first information field is used to instruct a first type terminal to perform system message update, and the second information field is used to instruct a second type terminal to perform system message update. The capability of the first type terminal is different from that of the second type terminal.

In the embodiment of the present disclosure, the first type terminal has a higher-level capability than the second type terminal. The second type terminal includes a first sub-type terminal and a second sub-type terminal. The second information field at least includes a first information sub-field and a second information sub-field. The first information sub-field is used to instruct the first sub-type terminal to perform system message update, and the second information sub-field is used to instruct the second sub-type terminal to perform system message update.

In the embodiment of the present disclosure, the first information field is a first number of bits in the short message information field, and the first number of bits are used to indicate different system messages for the first type terminal. The second information field is a second number of bits in the short message information field, and the second number of bits are used to indicate the system message for the first sub-type terminal and the system message for the second sub-type terminal, respectively.

In the embodiment of the present disclosure, the system messages of different types of terminals are different.

In the embodiment of the present disclosure, the determining module 202 is also used to trigger the information field corresponding to a type of terminal to indicate system message update in response to change in system message for the type of terminal among different types of terminals.

Regarding the apparatus in the above embodiments, the specific ways in which each module performs operations have been described in detail in the related method embodiments, and will not be explained in detail here.

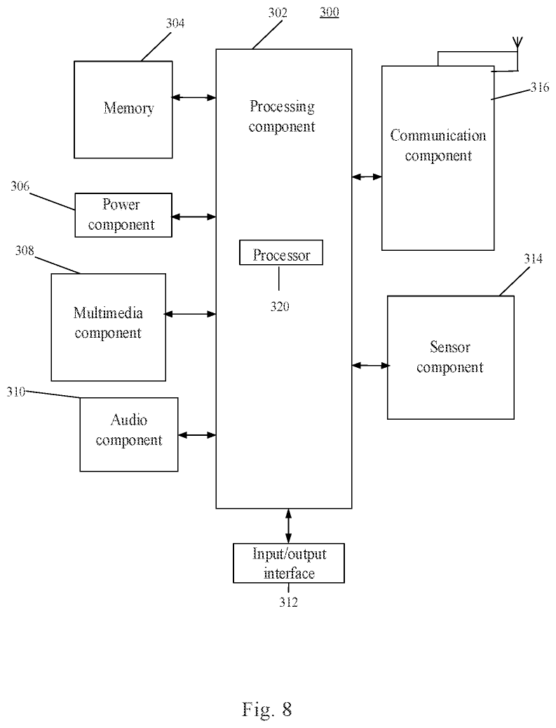

FIG. 8 is a block diagram of a system message update apparatus 300 illustrated according to an exemplary embodiment. For example, the apparatus 300 can be a mobile phone, computer, digital broadcasting terminal, messaging device, game console, tablet device, medical device, fitness device, personal digital assistant, etc.

Referring to FIG. 8, the apparatus 300 may include one or more of the following components: processing component 302, memory 304, power component 306, multimedia component 308, audio component 310, input/output (I/O) interface 312, sensor component 314, and communication component 316.

The processing component 302 typically controls the overall operation of the apparatus 300, such as operations associated with display, telephone calls, data communication, camera operations, and recording operations. The processing component 302 may include one or more processors 320 to execute instructions to complete all or part of the steps of the above method. In addition, the processing component 302 may include one or more modules to facilitate the interaction between the processing component 302 and other components. For example, processing component 302 may include a multimedia module to facilitate interaction between multimedia component 308 and processing component 302.

Memory 304 is configured to store various types of data to support operations on apparatus 300. Examples of these data include instructions for any application or method operated on apparatus 300, contact data, phone book data, messages, images, videos, etc. Memory 304 can be implemented by any type of volatile or non-volatile storage device or a combination of them, such as static random access memory (SRAM), electrically erasable programmable read-only memory (EEPROM), erasable programmable read-only memory (EPROM), programmable read only memory (PROM), read-only memory (ROM), magnetic memory, flash memory, magnetic disk or optical disc.

The power component 306 provides power to various components of the apparatus 300. The power component 306 may include a power management system, one or more power sources, and other components associated with generating, managing, and distributing power for apparatus 300.

The multimedia component 308 includes a screen providing an output interface between the apparatus 300 and the user. In some embodiments, the screen may include a liquid crystal display (LCD) and a touch panel (TP). If the screen includes a touch panel, the screen can be implemented as a touch screen to receive input signals from the user. The touch panel includes one or more touch sensors to sense touch, sliding, and gestures on the touch panel. The touch sensor can not only sense the boundary of touch or sliding actions, but also detect the duration and pressure related to the touch or sliding operation. In some embodiments, multimedia component 308 includes a front facing camera and/or a rear facing camera. When the apparatus 300 is in operating mode, such as shooting mode or video mode, the front camera and/or rear camera can receive external multimedia data. Each of the front and rear cameras can be a fixed optical lens system or has focal length and optical zoom capability.

Audio component 310 is configured to output and/or input audio signals. For example, audio component 310 includes a microphone (MIC) configured to receive external audio signals when apparatus 300 is in operating modes such as call mode, recording mode, and speech recognition mode. The received audio signal can be further stored in memory 304 or transmitted through communication component 316. In some embodiments, audio component 310 also includes a speaker for outputting audio signals.

The I/O interface 312 provides an interface between the processing component 302 and the peripheral interface module, which can be a keyboard, click wheel, button, etc. These buttons can include but are not limited to: home button, volume button, start button, and lock button.

The sensor component 314 includes one or more sensors for providing state evaluation of various aspects for the apparatus 300. For example, the sensor component 314 can detect the open/closed state of apparatus 300, the relative positioning of the components, and for example the components are the display and keypad of apparatus 300. The sensor component 314 can also detect change in the position of apparatus 300 or one component of apparatus 300, the presence or absence of user contact with apparatus 300, the orientation or acceleration/deceleration of apparatus 300, and temperature change of apparatus 300. The sensor component 314 can include a proximity sensor configured to detect the presence of nearby objects without any physical contact. The sensor component 314 can also include an optical sensor, such as CMOS or CCD image sensor, for use in imaging applications. In some embodiments, the sensor component 314 may also include an acceleration sensor, a gyroscope sensor, a magnetic sensor, a pressure sensor, or a temperature sensor.

The communication component 316 is configured to facilitate wired or wireless communication between the apparatus 300 and other device. The apparatus 300 can access wireless network based on any communication standard, such as WiFi, 2G, or 3G, or a combination of them. In an exemplary embodiment, the communication component 316 receives broadcast signals or broadcast related information from an external broadcast management system through a broadcast channel. In an exemplary embodiment, the communication component 316 further includes a Near Field Communication (NFC) module to facilitate short range communication. For example, the NFC module can be implemented based on radio frequency identification (RFID) technology, infrared data association (IrDA) technology, ultra wideband (UWB) technology. Bluetooth (BT) technology, and other technologies.

In exemplary embodiments, the apparatus 300 may be implemented by one or more of application specific integrated circuits (ASICs), digital signal processors (DSPDs), digital signal processing devices (DSPDs), programmable logic devices (PLDs), field programmable gate arrays (FPGAs), controllers, microcontrollers, microprocessors, or other electronic components for executing the above methods.

In exemplary embodiments, a non-transitory computer-readable storage medium including instructions is also provided, such as memory 304 including instructions, which can be executed by the processor 320 of the apparatus 300 to complete the above method. For example, the non-transitory computer readable storage medium can be ROM, random access memory (RAM). CD-ROM, magnetic tape, floppy disk, optical data storage device, etc.

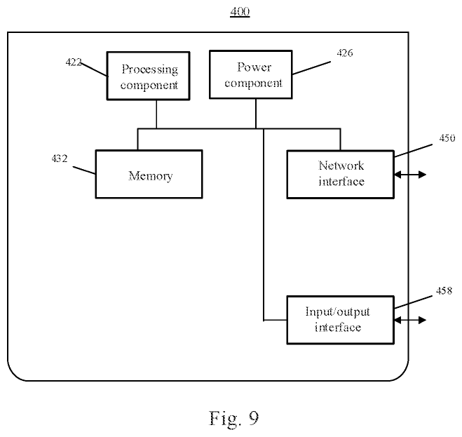

FIG. 9 is a block diagram of an apparatus 400 for updating system message illustrated according to an exemplary embodiment. For example, the apparatus 400 can be provided as a server. Referring to FIG. 9, apparatus 400 includes processing component 422, which further includes one or more processors, as well as memory resources represented by memory 432, for storing instructions that can be executed by the processing component 422, such as application programs. The application programs stored in the memory 432 may include one or more modules corresponding to a set of instructions. In addition, the processing component 422 is configured to execute instructions to execute the above method.

The apparatus 400 may also include a power component 426 configured to perform power management of the apparatus 400, a wired or wireless network interface 450 configured to connect the apparatus 400 to the network, and an input output (I/O) interface 458. The apparatus 400 can operate an operating system stored in the memory 432, such as Windows Server™, Mac OS X™, Unix™, Linux™, FreeBSD™, etc.

According to the embodiments of the present disclosure, by configuring different multiple information fields in the system message update indication, and instructing different types of terminals to perform system message update, it can achieve system message update indication for each type of terminal, reducing power waste of different types of terminals.

According to a first aspect of the embodiments of the present disclosure, it provides a system message update method, applied to a terminal, including: receiving a system message update indication, where the system message update indication includes a plurality of information fields, and the plurality of information fields are used to instruct different types of terminals to perform system message update: performing the system message update based on an information field corresponding to a type of the terminal.

In one embodiment, the plurality of information fields at least include a first information field and a second information field, the first information field is used to instruct a first type terminal to perform the system message update, and the second information field is used to instruct a second type terminal to perform the system message update: and a capability of the first type terminal is different from a capability of the second type terminal.

In one embodiment, the capability of the first type terminal has a higher level than the capability of the second type terminal: where the second type terminal includes a first sub-type terminal and a second sub-type terminal: the second information field at least includes a first information sub-field and a second information sub-field, the first information sub-field is used to instruct the first sub-type terminal to perform the system message update, and the second information sub-field is used to instruct the second sub-type terminal to perform the system message update.

In one embodiment, the first information field is a first number of bits in a short message information field, and the first number of bits are used to indicate different system messages for the first type terminal, respectively: and the second information field is a second number of bits in the short message information field, where the second number of bits are different from the first number of bits, and the second number of bits are used to indicate a system message for the first sub-type terminal and a system message for the second sub-type terminal, respectively.

In one embodiment, system messages for the different types of terminals are different.

According to a second aspect of the embodiments of the present disclosure, it provides a system message update method, applied to a network-side device, including: transmitting a system message update indication, wherein the system message update indication includes a plurality of information fields, and the plurality of information fields are used to instruct different types of terminals to perform system message update.

In one embodiment, transmitting the system message update indication includes: determining a type of a terminal: and transmitting a system message update indication indicating an information field corresponding to the type of the terminal.

In one embodiment, the plurality of information fields at least include a first information field and a second information field, the first information field is used to instruct a first type terminal to perform the system message update, and the second information field is used to instruct a second type terminal to perform the system message update: and a capability of the first type terminal is different from a capability of the second type terminal are different.

In one embodiment, the capability of the first type terminal has a higher level than the capability of the second type terminal: where the second type terminal includes a first sub-type terminal and a second sub-type terminal: the second information field at least includes a first information sub-field and a second information sub-field, the first information sub-field is used to instruct the first sub-type terminal to perform the system message update, and the second information sub-field is used to instruct the second sub-type terminal to perform the system message update.

In one embodiment, the first information field is a first number of bits in a short message, and the first number of bits are used to indicate different system messages for the first type terminal, respectively: and the second information field is a second number of bits in the short message information field, and the second number of bits are used to indicate a system message for the first sub-type terminal and a system message for the second sub-type terminal, respectively.

In one embodiment, system messages for the different types of terminals are different.

In one embodiment, the method further includes: in response to a change in a system message for one type of terminal among the different types of terminals, determining to trigger an information field corresponding to the type of the terminal to indicate system message update.

According to a third aspect of the embodiments of the present disclosure, it provides a system message update apparatus, applied to a terminal, including: a receiving module configured to receive a system message update indication, wherein the system message update indication includes a plurality of information fields, and the plurality of information fields are used to instruct different types of terminals to perform system message update: and an updating module configured to perform the system message update based on an information field corresponding to a type of the terminal.

In one embodiment, the plurality of information fields at least include a first information field and a second information field, the first information field is used to instruct a first type terminal to perform the system message update, and the second information field is used to instruct a second type terminal to perform the system message update: and a capability of the first type terminal is different from a capability of the second type terminal.

In one embodiment, the capability of the first type terminal has a higher level than the capability of the second type terminal: where the second type terminal includes a first sub-type terminal and a second sub-type terminal: the second information field at least includes a first information sub-field and a second information sub-field, the first information sub-field is used to instruct the first sub-type terminal to perform the system message update, and the second information sub-field is used to instruct the second sub-type terminal to perform the system message update.

In one embodiment, the first information field is a first number of bits in a short message information field, and the first number of bits are used to indicate different system messages for the first type terminal, respectively: and the second information field is a second number of bits in the short message information field, where the second number of bits are different from the first number of bits, and the second number of bits are used to indicate a system message for the first sub-type terminal and a system message for the second sub-type terminal, respectively.

In one embodiment, system messages for the different types of terminals are different.

According to a fourth aspect of the embodiments of the present disclosure, it provides a system message update apparatus, applied to a network-side device, including: a transmitting module configured to transmit a system message update indication, where the system message update indication includes a plurality of information fields, and the plurality of information field is used to instruct different types of terminals to perform system message update.

In one embodiment, the apparatus further includes a determining module configured to determine a type of a terminal: and a transmitting module configured to transmit a system message update indication indicating an information field corresponding to the type of the terminal.

In one embodiment, the plurality of information fields at least include a first information field and a second information field, the first information field is used to instruct a first type terminal to perform the system message update, and the second information field is used to instruct a second type terminal to perform the system message update: and a capability of the first type terminal is different from a capability of the second type terminal are different.

In one embodiment, the capability of the first type terminal has a higher level than the capability of the second type terminal: where the second type terminal includes a first sub-type terminal and a second sub-type terminal: the second information field at least includes a first information sub-field and a second information sub-field, the first information sub-field is used to instruct the first sub-type terminal to perform the system message update, and the second information sub-field is used to instruct the second sub-type terminal to perform the system message update.

In one embodiment, the first information field is a first number of bits in a short message, and the first number of bits are used to indicate different system messages for the first type terminal, respectively; and the second information field is a second number of bits in the short message information field, and the second number of bits are used to indicate a system message for the first sub-type terminal and a system message for the second sub-type terminal, respectively.

In one embodiment, system messages for the different types of terminals are different.

In one embodiment, the determining module is further configured to: in response to a change in a system message for one type of terminal among the different types of terminals, determine to trigger an information field corresponding to the type of the terminal to indicate system message update.

According to a fifth aspect of the embodiments of the present disclosure, it provides a system message update apparatus, including: a processor: a memory configured to store processor executable instructions: where the processor is configured to execute the system message update method according to the first aspect or any implementation in the first aspect, or to execute the system message update method according to the second aspect or any implementation in the second aspect.

According to a sixth aspect of the embodiments of the present disclosure, it provides a non-transitory computer-readable storage medium, wherein a mobile terminal is enabled to execute the system message update method according to the first aspect or any implementation in the first aspect when instructions in the storage medium are executed by a processor of the mobile terminal, or the mobile terminal is enabled to execute the system message update method according to the second aspect or any implementation in the second aspect.

It can be further understood that in this disclosure, “a plurality of” refers to two or more, and other quantifiers are similar. “And/or” describes the association relationship of the associated object, indicating that there can be three types of relationships. For example, A and/or B can represent: A exists alone, A and B exist together, and B exists alone. The character “/” generally indicates that the associated object is an “or” relationship. The singular forms of “a”, “said”, and “the” are also intended to include the majority form, unless the context clearly indicates otherwise.

It can be further understood that the terms “first”, “second”, etc., are used to describe various information, but the information should not be limited to these terms. These terms are only used to distinguish the same type of information from each other and do not indicate a specific order or degree of importance. In fact, expressions such as “first” and “second” can be used interchangeably. For example, without departing from the scope of this disclosure, the first information can also be referred to as the second information, and similarly, the second information can also be referred to as the first information.

It can be further understood that in the embodiments of the present disclosure, although the operations are described in a specific order in the accompanying drawings, it should not be understood as requiring the execution of these operations in the specific or serial order shown, or requiring the execution of all the operations shown to achieve the desired results. In specific environments, multitasking and parallel processing may be advantageous.

After considering the specifications and practices of the present disclosure herein, those skilled in the art will easily conceive of other embodiments of the present disclosure. The purpose of this application is to cover any variations, uses, or adaptations of the present disclosure, which follow the general principles of the present disclosure and include common knowledge or commonly used technical means in the technical field that are not disclosed in the present disclosure. The specification and embodiments are only considered exemplary, and the true scope and spirit of this disclosure are indicated by the following claims.

It should be understood that the present disclosure is not limited to the precise structure already described above and shown in the accompanying drawings, and various modifications and changes can be made without departing from its scope. The scope of this disclosure is limited only by the accompanying claims.

1. A system message update method, performed by a terminal, comprising:
receiving a system message update indication, wherein the system message update indication comprises a plurality of information fields, and the plurality of information fields are used to instruct different types of terminals to perform system message update; and
performing the system message update based on an information field corresponding to a type of the terminal.

2. The system message update method according to claim 1, wherein the plurality of information fields at least comprise a first information field and a second information field, the first information field is used to instruct a first type terminal to perform the system message update, and the second information field is used to instruct a second type terminal to perform the system message update; and
a capability of the first type terminal is different from a capability of the second type terminal.

3. The system message update method according to claim 2, wherein the capability of the first type terminal has a higher level than the capability of the second type terminal; wherein the second type terminal comprises a first sub-type terminal and a second sub-type terminal; and
the second information field at least comprises a first information sub-field and a second information sub-field, the first information sub-field is used to instruct the first sub-type terminal to perform the system message update, and the second information sub-field is used to instruct the second sub-type terminal to perform the system message update.

4. The system message update method according to claim 3, wherein the first information field is comprises a first number of bits in a short message information field, and the first number of bits are used to indicate different system messages for the first type terminal, respectively; and
the second information field comprises a second number of bits in the short message information field, wherein the second number of bits are different from the first number of bits, and the second number of bits are used to indicate a system message for the first sub-type terminal and a system message for the second sub-type terminal, respectively.

5. The system message update method according to claim 1, wherein system messages for the different types of terminals are different.

6. A system message update method, performed by a network-side device, comprising:
transmitting a system message update indication, wherein the system message update indication comprises a plurality of information fields, and the plurality of information fields are used to instruct different types of terminals to perform system message update.

7. The system message update method according to claim 6, wherein transmitting the system message update indication comprises:
determining a type of a terminal; and
transmitting the system message update indication indicating an information field corresponding to the type of the terminal.

8. The system message update method according to claim 6, wherein the plurality of information fields at least comprise a first information field and a second information field, the first information field is used to instruct a first type terminal to perform the system message update, and the second information field is used to instruct a second type terminal to perform the system message update; and
a capability of the first type terminal is different from a capability of the second type terminal.

9. The system message update method according to claim 8, wherein the capability of the first type terminal has a higher level than the capability of the second type terminal; wherein, the second type terminal comprises a first sub-type terminal and a second sub-type terminal; and
the second information field at least comprises a first information sub-field and a second information sub-field, the first information sub-field is used to instruct the first sub-type terminal to perform the system message update, and the second information sub-field is used to instruct the second sub-type terminal to perform the system message update.

10. The system message update method according to claim 9, wherein the first information field comprises a first number of bits in a short message information field, and the first number of bits are used to indicate different system messages for the first type terminal, respectively; and
the second information field is comprises a second number of bits in the short message information field, and the second number of bits are used to indicate a system message for the first sub-type terminal and a system message for the second sub-type terminal, respectively.

11. The system message update method according to claim 6, wherein system messages for the different types of terminals are different.

12. The system message update method according to claim 6, wherein the method further comprises:
in response to a change in a system message for one type of terminal among the different types of terminals, determining to trigger an information field corresponding to the type of the terminal to indicate system message update.

13-14. (canceled)

15. A system message update apparatus, comprising:
a processor; and
a memory configured to store processor executable instructions;
wherein the processor is configured to execute the following steps when the processor executable instructions are executed by the processor;
receiving a system message update indication, wherein the system message update indication comprises a plurality of information fields, and the plurality of information fields are used to instruct different types of terminals to perform system message update; and
performing the system message update based on an information field corresponding to a type of the terminal.

16. (canceled)

17. The system message update apparatus according to claim 15,
wherein the plurality of information fields at least comprise a first information field and a second information field, the first information field is used to instruct a first type terminal to perform the system message update, and the second information field is used to instruct a second type terminal to perform the system message update; and
a capability of the first type terminal is different from a capability of the second type terminal.

18. The system message update apparatus according to claim 17, wherein the capability of the first type terminal has a higher level than the capability of the second type terminal; wherein the second type terminal comprises a first sub-type terminal and a second sub-type terminal; and
the second information field at least comprises a first information sub-field and a second information sub-field, the first information sub-field is used to instruct the first sub-type terminal to perform the system message update, and the second information sub-field is used to instruct the second sub-type terminal to perform the system message update.

19. The system message update apparatus according to claim 18, wherein the first information field comprises a first number of bits in a short message information field, and the first number of bits are used to indicate different system messages for the first type terminal, respectively; and
the second information field comprises a second number of bits in the short message information field, wherein the second number of bits are different from the first number of bits, and the second number of bits are used to indicate a system message for the first sub-type terminal and a system message for the second sub-type terminal, respectively.

20. The system message update apparatus according to claim 15, wherein system messages for the different types of terminals are different.
